(19) United States
(12) Patent Application Publication
(10) Pub. No.: US 2013/0243085 A1
(43) Pub. Date: Sep. 19, 2013

(54) METHOD OF MULTI-VIEW VIDEO CODING AND DECODING BASED ON LOCAL ILLUMINATION AND CONTRAST COMPENSATION OF REFERENCE FRAMES WITHOUT EXTRA BITRATE OVERHEAD

(71) Applicant: SAMSUNG ELECTRONICS CO., LTD., Suwon-si (KR)

(72) Inventors: Igor Mironovich KOVLIGA, Povarovo (RU); Alexey Mikhailovich FARTUKOV, Moscow (RU); Michael Naumovich MISHOUROVSKY, Moscow (RU)

(73) Assignee: SAMSUNG ELECTRONICS CO., LTD., Suwon-si (KR)

(21) Appl. No.: 13/795,301

(22) Filed: Mar. 12, 2013

(30) Foreign Application Priority Data
Mar. 15, 2012 (RU) 2012109843
Mar. 8, 2013 (KR) 10-2013-0025130

(51) Int. Cl. H04N 7/26

(52) U.S. Cl. CPC H04N 19/00769
USPC 375/240.12

(57) ABSTRACT

Provided is an illumination and contrast compensation method applied to the frames comprising multi-view video sequence. Relations between the values of the pixels of the reference block and the values of the pixels neighboring the reference block and relations between the restored values of the pixels neighboring the current block and the values of the pixels neighboring the reference block is determined. An illumination and contrast compensation parameters for illumination and contrast compensation of discrepancy (mismatch) compensation between reference and encoded blocks is determined on the basis of the determined relations, values of the pixels of the reference block, restored values of the pixels neighboring the current block and values of the pixels neighboring the reference block.

### CROSS-REFERENCE TO RELATED APPLICATION

This application claims the priority benefit of Russian Patent Application No. 2012-109843, filed on Mar. 15, 2012, in the Russian Patent and Trademark Office, and Korean Patent Application No. 10-2013-0025130, field on Mar. 8, 2013, in the Korean Intellectual Property Office, the disclosure of which is incorporated herein by reference.

### BACKGROUND

1. Field

Example embodiments relate to an illumination and contrast compensation method applied to the frames comprising multi-view video sequence, and more particularly, to a method for illumination and contrast compensation for multi-view video coding.

2. Description of the Related Art

One of a number of multi-view video coding methods is concluded in usage of frames from adjacent views or frames which are synthesized from adjacent views as reference frames for predictive coding [Yea, S.; Vetro, A., “View Synthesis Prediction for Multiview Video Coding”, Image Communication, ISSN: 0923-5965, Vol. 24, Issue 1-2, pp. 89-100, January 2009]. In a predictive coding, a displacement of an object between currently coded frame and one of reference frames is compensated. The term “displacement” refers to the motion of an object or difference in position of an object on frames from adjacent views or synthesized frames for currently coded view. Result of the compensation is inter-frame difference for image signal. The difference is coded in subsequent encoding stages (for example, differences are transformed, quantized and coded by entropy coder).

There are differences in parameters of cameras which are used for multi-view video sequences capturing and differences in light flux that is registered by the particular camera. Presence of mentioned differences leads to possible illumination and contrast difference between frames from adjacent views. Furthermore, the illumination and contrast differences affect the characteristics of synthesized frames. It can significantly decrease compression efficiency of predictive coding of multi-view video sequences.

In order to solve problem mentioned above, H.264 standard [ITU-T Rec. H.264. Advanced video coding for generic audiovisual services. 2010] uses a weighted prediction technique which is originally developed to compensate fade-up, fade-down, flickering or scene change effects in case of single video sequence coding. This weighted prediction technique allows suppressing illumination changes between coding and reference frames. Weighted prediction is applied to motion and displacement compensation at the macroblock level. Weighting factors are the same for all macroblocks of a particular slice, thus they can be considered as global ones. Weighting factors are determined and stored in bitstream (“explicit” weighted prediction) or calculated during decoding (“implicit” weighted prediction). But in case of multi-view video sequences there are local illumination and contrast changes which make this technique less effective.

Another approach to solve the problem is adaptive block-wise illumination compensation technique [U.S. Pat. No. 7,924,923. Motion Estimation and Compensation Method and Device Adaptive to Change in Illumination. April, 2011]. One modification of this technique devoted to multi-view video coding is called “Multi-view One-Step Affine Illumination Compensation” (MOSAIC) [Y. Lee, J. Hur, Y. Lee, R. Han, S. Cho, N. Hur, J. Kim, J. Kim, P. Lai, A. Ortega, Y. Su, P. Yin and C. Gomila. CE11: Illumination compensation. Joint Video Team (JVT) of ISO/IEC MPEG and ITU-T VCEG JVT-U052, Oct. 2006; and J. H. Kim, P. Lai, J. Lopez, A. Ortega, Y. Su, P. Yin, and C. Gomila. New coding tools for illumination and focus mismatch compensation in multiview video coding. IEEE Trans. on Circuits and Systems for Video Technology, vol. 17, no. 11, pp. 1519-1535, November 2007]. The method is a combination of block-wise illumination compensation and inter prediction techniques which are described in H.264 standard. In each step of modified inter prediction procedure, mean values for the currently coded block and the reference block are calculated. Then mean-removed versions for mentioned above blocks are composed. After that, sum of absolute differences for mean-removed blocks (Mean-Removed Sum of Absolute Difference—MRSAD) is calculated. Result of the inter prediction is relative coordinates of reference block (displacement vector) which gives minimal value of encoding cost. Calculation of the encoding cost is based on MRSAD value and estimation of side information which should be transmitted for further decoding. Besides displacement vector, side information also includes difference between mean values of current and reference blocks (called Difference Value of Illumination Compensation—DVIC). Note, that in so-called “P Skip” coding mode (that is one of modes used in the encoding and that of one of modes used for realizing this coding method) DVIC value is derived from DVIC values of already encoded adjacent macroblocks without transmission of any additional information. Nevertheless, above method does not allow avoiding transmission of additional side information (DVIC) for decoding.

Parameters of illumination and contrast compensation can be derived from restored (already encoded/decoded) areas of the frames. This can help to reduce amount of side information which should be encoded and transmitted explicitly in the bitstream. Mentioned technique was realized in the method of Weighted Prediction using Neighboring Pixels (WPNP) [T. Yamamoto, T. Ikai, “Weighted prediction using neighboring pixels,” ITU-T Q.6/SG16 VCEG, Proposal VCEG-AH19, January 2008]. This method utilizes pixels surrounding current block and pixels surrounding reference block for estimating pixel-wise illumination changes. In this case illumination changes of two neighbor pixels are weighted and added to be the estimated illumination changes for pixels of current and reference blocks. Weighted coefficients are defined for each pixel of the current block. Value of weighted coefficients depends on distance between pixel of current block and neighbor pixels. Main drawback of this analog is that reduction of side information is achieved by potential reduction of quality of illumination change prediction. Reason of the quality reduction is that illumination changes for neighbor pixel can be differ from illumination changes for pixels of current and reference blocks.

Another realization of illumination and contrast parameter estimation by analysis of restored (already coded/decoded) areas of the frames is described in patent application US 2011/0286678 [Multi-view Image Coding Method, Multi-view Image Decoding Method, Multi-view Image Coding Device, Multi-view Image Decoding device, Multi-view Image Coding Program, and Multi-view Image Decoding Program. November, 2011]. The method of coding multi-view video sequences includes illumination compensation stage during the predictive coding. The illumination compensation parameters are estimated from adjacent areas of the currently coded and the reference areas (blocks). Because the adjacent areas can be acquired at decoding side, it is not necessary to encode the illumination compensation parameters. Obtained parameters are applied to illumination compensation of the reference area (block). Reliability of the illumination change estimation is forecasted by correcting adjacent area of the reference area (block) using estimated illumination compensation parameters, and then comparing the result of this with already coded/decoded adjacent area of the currently coded area (block). The drawback of mentioned analog is that reliability is only determined by analysis of the adjacent areas. Information which is contained in the reference area is not used in analysis of illumination compensation reliability. Thus errors during illumination compensation are possible.

Another method is described in patent application US 2008/0304760 [Method and Apparatus for Illumination Compensation and Method and Apparatus for Encoding and Decoding Image Based on Illumination Compensation. December, 2008]. The method of compensating for illumination and contrast of reference block includes following steps: receiving inputs of restored values of pixels neighboring a current block and restored values of pixels neighboring the reference block; predicting mean values of pixels of current block and the reference block, based on the input restored values of pixels neighboring the current block and the input restored values of pixels neighboring the reference block; based on the predicted mean value of the pixels of the current block, the predicted mean value of the pixels of the reference block, and the values of the pixels of the current block and reference block, determining an illumination compensation parameters for illumination compensation of the reference block; and performing illumination compensation of the reference block, by using the determined illumination compensation parameter.

The drawback of the prototype is as follows. Restored values of the pixels neighboring the current block and the reference block are used for prediction of mean values only. This restriction does not allow using information which is contained in the neighboring areas. Moreover, analysis of relations between values of the pixels from the reference block and values of the pixels neighboring the reference block is not performed. Thus, possible difference in illumination and contrast parameters between currently coded block and neighbor areas is not considered in the prototype. This leads to decrease of reliability of illumination change compensation and has negative influence on compression efficiency of predictive coding.

According to prototype [US patent application 2008/0304760. Method and Apparatus for Illumination Compensation and Method and Apparatus for Encoding and Decoding Image Based on Illumination Compensation. December, 2008] method of encoding an image based on illumination compensation comprises: determining a reference block to be used for generating a predicted block of a current block; determining an illumination compensation parameter for illumination compensation of the determined reference block; by using the determined illumination compensation parameter, performing illumination compensation of the determined reference block; generating the predicted block of the current block, by using the illumination-compensated reference block, and by encoding the difference value between the generated predicted block and the current block, generating a bitstream; and storing information on the determined illumination compensation parameter in a predetermined area of the generated bitstream. The drawback of this method is requirement of storing illumination compensation parameters in generating bitstream.

### SUMMARY

The present disclosure is intended for improvement of multiview coding if hybrid approach is used and is concluded in getting more reliable procedure of illumination and contrast parameter estimation and compensation. The improvement is achieved by using more information for estimation of illumination and contrast change parameters. More precisely, the claimed method uses relations between values of the pixels of the reference blocks and restored values of pixels neighboring reference block, and relations between restored values of the pixels neighboring current and reference blocks respectively.

A method for multi-view video encoding and decoding that is based on the illumination and contrast compensation improves compression efficiency because illumination change estimation uses values of pixels from areas which are available at the encoding side as well as at decoding side and illumination compensation parameters can be precisely reconstructed without transmitting extra information regarding illumination compensation parameters.

According to the basic aspect of the example embodiments, a method for local compensating of illumination and contrast discrepancy (mismatch) between reference block and encoded block at the predicting stage of a multi-view coding process is claimed, comprising the operation of:
receiving values of pixels of a current block in the encoded frame and values of pixels of a reference block in the reference frame;
receiving already decoded and restored values of the pixels neighboring the current block of the currently coded frame and the values of the pixels neighboring the reference block of the reference frame;
determining relations between the values of the pixels of the reference block and the values of the pixels neighboring the reference block and relations between the restored values of the pixels neighboring the current block and the values of the pixels neighboring the reference block;
determining an illumination and contrast compensation parameters for illumination and contrast compensation of discrepancy (mismatch) compensation between reference and encoded blocks on the basis of the determined relations, values of the pixels of the reference block, restored values of the pixels neighboring the current block and values of the pixels neighboring the reference block; and
performing illumination and contrast compensation of the discrepancy (mismatch) between reference and encoded block, by using the determined illumination and contrast compensation parameters.

According to another aspect of the example embodiments, the method mentioned above is modified in such a way as to enable determining relations for the pixels of the currently coded frame and the reference frame, and determining an illumination and contrast compensation parameters comprising the operations of:
calculating statistical characteristics of the values of the restored pixels neighboring the current block, statistical characteristics of the values of the pixels of the reference block and statistical characteristics of the values of the pixels neighboring the reference block;
determining relations between statistical characteristics for the values of the pixels of the reference block and the restored values of the pixels neighboring the reference block; and
determining an illumination and contrast compensation parameter for illumination and contrast compensation of the reference block on the basis of calculated statistical characteristics and relations between them.

According to still another aspect of the example embodiments, the method mentioned above is modified in such a way as to enable calculating the statistical characteristics, determining relations for the statistical characteristics and determining an illumination and contrast compensation parameter comprise:
calculating mean value for the restored pixels neighboring the current block and located to the left of the current block, mean value for the restored pixels neighboring the current block and located on the top of the current block, mean value for the pixels of the reference block, mean value of the pixels neighboring the reference block and located to the left of the reference block, and mean value of the pixels neighboring the reference block and located on the top of the reference block;
in case of presence of the restored pixels neighboring the current block and located to the left of the current block and presence of the pixels neighboring the reference block and located to the left of the reference block, calculating ratio value between the mean value of the pixels of the reference block and the mean value of the pixels neighboring the reference block and located to the left of the reference block; calculating product of the ratio value and the mean value of the restored pixels neighboring the current block and located to the left of the current block; determining an illumination and contrast compensation parameter as ratio between calculated product and mean value for the pixels of the reference block;
otherwise, in case of presence of the restored pixels neighboring the current block and located over the current block and presence of the pixels neighboring the reference block and located over the reference block, calculating ratio value between the mean value of the pixels of the reference block and the mean value of the pixels neighboring the reference block and located over the reference block; calculating product of the ratio value and the mean value of the restored pixels neighboring the current block and located over the current block; determining an illumination and contrast compensation parameter as ratio between calculated product and mean value for the pixels of the reference block; and
otherwise, using Median Adaptive Prediction for calculation of estimation for mean value of the current block; determining an illumination and contrast compensation parameter as ratio between the estimated mean value of the pixels of the current block and the mean value for the pixels of the reference block.

According to still another aspect of the example embodiments, the method mentioned above is modified in such a way as to enable compensating the illumination and contrast of a reference block during multi-view coding process, including:
receiving inputs of values of pixels of a current block of a currently coded frame and values of pixels of a reference block of a reference frame;
receiving inputs of restored (encoded and then decoded) values of pixels neighboring the current block of the currently coded frame and values of pixels neighboring the reference block of the reference frame;
calculating a first estimation value estD_{i,j} for each pixel position (i,j) in the reference block; the first estimation value estD_{i,j} is a function of a linear combination of the restored values Tₖ^{D} of the pixels neighboring the current block, k−0, . . . , N−1, N is amount of pixels neighboring the current block and the reference block;
calculating a second estimation value estR_{i,j} for each pixel position (i,j) in the reference block; the second estimation value estR_{i,j} is a function of a linear combination of the values Tₖ^{R} of the pixels neighboring the reference block, k=0, . . . , N 1;
determining an illumination and contrast compensation parameter for illumination and contrast compensation for each pixel position in the reference block on the basis of the first estimation value estD_{i,j}, the second estimation value estR_{i,j}, the values R_{i,j} of pixels of the reference block, the restored values Tₖ^{D} of the pixels neighboring the current block and the values Tₖ^{R} of the pixels neighboring the reference block; and
performing illumination and contrast compensation for each pixel position in the reference block, by using the determined illumination compensation parameters.

According to another aspect of the example embodiments, the method mentioned above is modified in such a way as to enable calculating of the first estimation value and the second estimation value for each pixel position in the reference block, and determining an illumination and contrast compensation parameters for each pixel position in the reference block comprise:
calculating the first estimation value estD_{i,j} as

estD_{i,j}=Σ_{k=0 . . . N-1}Wₖ(i,j)·Tₖ^{D},
where Wₖ(i,j), k=0, . . . , N−1 are weighted coefficients, and Tₖ^{D}, k=0, . . . , N−1 is the restored values of the pixels neighboring the current block, N is amount of pixels neighboring the current block and the reference block;
calculating the second estimation value estR_{i,j} as

estR_{i,j}=Σ_{k=0 . . . N-1}Wₖ(i,j)·Tₖ^{R},
where Wₖ(i,j), k−0, . . . , N are weighted coefficients, and Tₖ^{R}, k−0, . . . , N−1 is the values of the pixels neighboring the reference block, is amount of pixels neighboring the current block and the reference block; and
determining an illumination and contrast compensation parameter for illumination and contrast compensation for each pixel position in the reference block; this parameter is a ratio

$${α}_{i , j} = \frac{{estD}_{i , j}}{{estR}_{i , j}} .$$

According to another aspect of the example embodiments, the method mentioned above is modified in such a way as to enable calculating the first estimation value and the second estimation value for each pixel position in the reference block comprise:
calculating predetermined weighted coefficients Wₖ(i,j), k=0, . . . , N for the first estimation value estD_{i,j} and the second estimation value estR_{i,j}; for each pixel position (i,j) in the reference block the weighted coefficient Wₖ(i,j) is equal to the non-increasing function of the absolute difference:

|R_{i,j}−Tₖ^{R}|,
that provides inverse proportional increasing/decreasing of Wₖ(i,j) depending on decreasing/increasing the absolute difference correspondently. Here R_{i,j} is the value of the pixel of the reference block; Tₖ^{R} (k=0, . . . , N−1) is the value of the pixel neighboring the reference block; N is amount of pixels neighboring the current block and the reference block.

According to another aspect of the example embodiments, the method mentioned above is modified in such a way as to enable calculating the first estimation value and the second estimation value for each pixel position in the reference block comprise:
calculating weighted coefficients Wₖ(i,j), k=0, . . . , N−1 for the first estimation value estD_{i,j} and the second estimation value estR_{i,j} for each pixel position (i,j) in the reference block the weighted coefficient Wₖ(i,j) is equal to the non-increasing function of the absolute difference:

|R_{i,j}−Tₖ^{R}|,
that provides inverse proportional increasing/decreasing of Wₖ(i,j) depending on decreasing/increasing the absolute difference correspondently; in case of

|Tₖ^{R}−R_{i,j}|≦Thr,
where Thr is predetermined threshold; otherwise Wₖ(i,j)=0. Here R_{i,j} is the value of the pixel of the reference block; Tₖ^{R} (k=u, . . . , N−1) is the value of the pixel neighboring the reference block; N is amount of pixels neighboring the current block and the reference block.

In embodying the claimed disclosure it seems to be reasonable to use still another aspect of the above method, wherein calculating the first estimation value and the second estimation value for each pixel position in the reference block comprise:
calculating weighted coefficients Wₖ(i,j), k=0, . . . N−1 for the first estimation value estD_{i,j} and the second estimation value estR_{i,j}; for each pixel position (i,j) in the reference block the weighted coefficient Wₖ(i,j) is equal to the non-increasing function of an absolute difference:

|R_{i,j}Tₖ^{R}|,
that provides inverse proportional increasing/decreasing of Wₖ(i,j) depending on decreasing/increasing the absolute difference correspondently; in case of

|Tₖ^{R}−Tₖ^{D}|≦Thr1,
where Tₖ^{D} (k−0, . . . , N) is the value of the pixel neighboring the current block, Thr1 is a first predetermined threshold; and

|Tₖ^{R}−R_{i,j}|≦Thr2,
where Thr2 is a second predetermined threshold; otherwise Wₖ(i,j)=0. Here R_{i,j} is the value of the pixel of the reference block; Tₖ^{R} (k=0, . . . , N−1) is the value of the pixel neighboring the reference block; N is amount of pixels neighboring the current block and the reference block.

In embodying the claimed disclosure it seems to be reasonable to use still another aspect of the above method wherein the method is modified in such a way as to enable calculating the first estimation value and the second estimation value for each pixel position in the reference block comprise:
calculating predetermined weighted coefficients Wₖ(i,j), k=0, . . . , N 1 for the first estimation value estD_{i,j} the second estimation value estR_{i,j}; for each pixel position (i,j) in the reference block the weighted coefficient Wₖ(i,j) is equal to

Wₖ(i,j)=exp(−C·Aₖ(i,j)),
where C is predetermined constant greater than 0 and Aₖ(i,j) equals

Aₖ(i,j)=|R_{i,j}−Tₖ^{R}|,
where R_{i,j} is the value of the pixel of the reference block, Tₖ^{R} (k=0, . . . , N−1) is the value of the pixel neighboring the reference block, in case of

|Tₖ^{R}−R_{i,j}|≦Thr,
where Thr is predetermined threshold; otherwise Wₖ(i,j)=0.

According to another variant, the modification of the mentioned above method is claimed, wherein the calculating the first estimation value and the second estimation value for each pixel position in the reference block comprise:
calculating predetermined weighted coefficients Wₖ(i,j), k−0, . . . , N−1 for the first estimation value estD_{i,j} and the second estimation value estR_{i,j}; for each pixel position (i,j) in the reference block the weighted coefficient Wₖ(i,j) is equal to

Wₖ(i,j)=exp(−C·Aₖ(i,j)),
where C is predetermined constant greater than 0 and Aₖ(i,j) equals

Aₖ(i,j)=|R_{i,j}−Tₖ^{R}|,
where R_{i,j} is the value of the pixel of the reference block, Tₖ^{H} (k=0, . . . , N−1) is the value of the pixel neighboring the reference block, in case of

|Tₖ^{R}−Tₖ^{D}|≦Thr1,
where Tₖ^{D} (k=0, . . . , N) is the value of the pixel neighboring the current block, Thr1 is a first predetermined threshold; and

|Tₖ^{R}−R_{i,j}|≦Thr2,
where Thr2 is a second predetermined threshold; otherwise Wₖ(i,j)=0.

According to another embodiment, the above method is modified in such a way as to enable determining the positions of the restored values of the pixels neighboring the current block and the position values of the pixels neighboring the reference block, where these positions are determined adaptively instead of the corresponding pixels having the preset neighboring the reference block of the reference frame.

The group of inventions united by the common concept comprises a unique method for multi-view video encoding based on the illumination and contrast compensation. The method includes:
determining a reference block that is used for generating a predicted block for a current block;
determining an illumination and contrast compensation parameters for illumination and contrast compensation of the discrepancy (mismatch) between reference block during or after determination of the reference block;
performing illumination and contrast compensation of the determined reference block by using the determined illumination and contrast compensation parameters;
generating the predicted block for the current block by using the illumination and contrast compensated reference block; and
encoding the current block by the generated predicted block without encoding of determined illumination and contrast compensation parameters; encoding of an information about the reference block if it is needed for decoding;
   wherein the determining of the illumination and contrast compensation parameters comprises:
receiving reconstructed (already decoded) values of the pixels neighboring the current block and values of the pixels neighboring the reference block;
determining relations between the values of the pixels of the reference block and the values of the pixels neighboring the reference block and relations between the restored values of the pixels neighboring the current block and the values of the pixels neighboring the reference block; and
determining an illumination and contrast compensation parameters for illumination and contrast compensation of the reference block is based on the determined relations, values of the pixels of the reference block, restored values of the pixels neighboring the current block and values of the pixels neighboring the reference block.
Within the common concept another unique method for multi-view video decoding based on the illumination and contrast compensation. The method comprises:
decoding information about a reference block if it is needed for determining the reference block of the current block and determining the reference block;
determining an illumination and contrast compensation parameters for illumination and contrast compensation of the determined reference block;
performing illumination and contrast compensation of the determined reference block by using the determined illumination and contrast compensation parameters;
generating the predicted block for the current block, by using the illumination and contrast compensated reference block; and
decoding the current block by using the generated predicted block and the determined illumination and contrast compensation parameters,
   wherein the determining of the illumination and contrast compensation parameters comprises:
receiving reconstructed (already decoded) values of the pixels neighboring the current block and values of the pixels neighboring the reference block;
determining relations between the values of the pixels of the reference block and the values of the pixels neighboring the reference block and relations between the restored values of the pixels neighboring the current block and the values of the pixels neighboring the reference block; and
determining an illumination and contrast compensation parameter for illumination and contrast compensation of the reference block that is based on the determined relations, values of the pixels of the reference block, restored values of the pixels neighboring the current block and values of the pixels neighboring the reference block.

Further, example embodiments are explained with references to the corresponding drawings.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 is a high-level structure of a hybrid multi-view coding environment in the multi-view coding environment;

FIG. 2 is a scheme of a part of the hybrid video encoder which implements claimed method which is included into the predictive coding;

FIG. 3 is a diagram for explaining a method of compensating for illumination and contrast of a reference block in accordance with an exemplary embodiment;

FIG. 4 is a flowchart illustrating a method of compensating for illumination and contrast of a reference block, according to an exemplary embodiment;

FIG. 5 is a diagram for explaining procedure of input block selection in a current frame during calculation illumination and contrast compensation parameter, according to an exemplary embodiment;

FIG. 6 is a diagram for explaining a method of compensating for illumination and contrast of a reference block in accordance with another embodiment;

FIG. 7 is a flowchart illustrating a method of pixel-wise illumination and contrast compensation of a reference block according to an exemplary embodiment;

FIG. 8 is a diagram for explaining a method of compensating for illumination and contrast of a reference block in accordance with another embodiment;

FIG. 9 is a flowchart which describes a method for multi-view video encoding based on the illumination and contrast compensation according to an exemplary embodiment; and

FIG. 10 is a flowchart which describes a method for multi-view video decoding based on the illumination and contrast compensation according to an exemplary embodiment.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

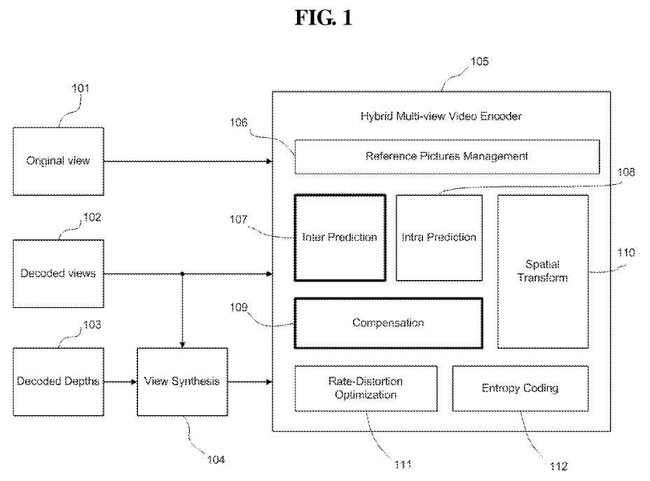

FIG. 1 shows the structure of a hybrid multi-view coding device. Input data of the hybrid multi-view video encoder 105 includes original view 101 and already coded/decoded views 102 which are part of encoded multi-view video data. Already coded/decoded views 102 and already coded/decoded depth sequences 103 are used for generation of synthesized view for the original view by a view synthesis 104. The generated synthesized view video sequence is also input data for the hybrid multi-view video encoder 105.

The hybrid multi-view video encoder 105 contains the following tools which are used for encoding of the original view: reference picture management 106, inter-frame prediction 107, intra-frame prediction 108, inter and intra-frame compensation 109, spatial transform 110, rate-distortion optimization 111 and entropy coding 112. More detailed information about mentioned tools is given in [Richardson I.E. The H.264 Advanced Video Compression Standard. Second Edition. 2010]. The claimed method can be implemented inside inter-frame prediction 107.

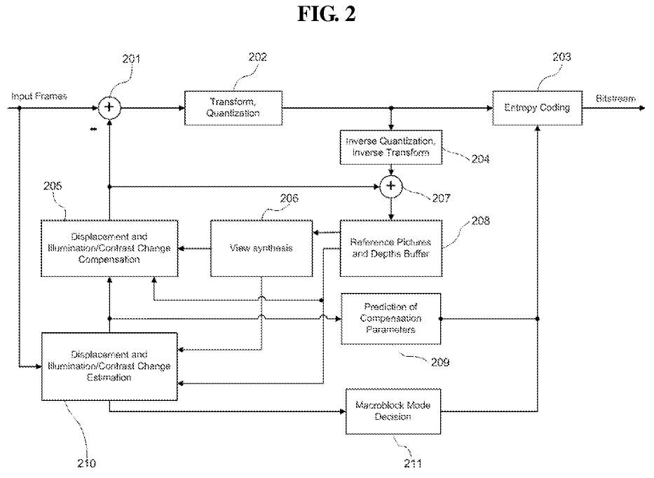

FIG. 2 shows a scheme of a part of the hybrid video encoder which implements the claimed method which is included into the predictive coding. The hybrid encoder includes subtraction unit 201, transform and quantization unit 202, entropy encoding unit 203, inverse transform and inverse quantization unit 204, displacement and illumination/contrast change compensation unit 205, view synthesis unit 206, addition unit 207, reference pictures and depths buffer unit 208, prediction of compensation parameters unit 209, displacement and illumination/contrast change estimation unit 210 and macroblock mode decision unit 211. Units 201-204, 207-209 and 211 are the standard encoding units which are used in the basic hybrid coding method [Richardson I.E. The H.264 Advanced Video Compression Standard. Second Edition. 2010]. View synthesis unit 206 is specific unit for multi-view coding. The unit 206 synthesizes an additional reference frames from already encoded/decoded frames and depth data.

The claimed method can be implemented inside units 205 and 210. These units realize block-wise predictive coding technique, which contains the following steps:
for the current block of the currently coded frame the search for the reference block is performed which minimizes the following expression:

$${\sum }_{m = 1}^{M} {\sum }_{n = 1}^{N} \vert I ( m , n ) - Ψ ( R ( m + i , n + j ) ) \vert$$

where I(m,n) represents luminance value of pixel at position (m,n) of the current block with size M×N. (i,j) specifies displacement vector (DV) which points to the reference block R within a predetermined search area. Ψ(x) means a function which somehow compensates illumination and contrast changes between the current block and the reference block. This technique is realized in the unit 210. Determined parameters of illumination and contrast compensation along with obtained DV are transmitted to unit 205 and unit 209.
   The selected reference block is modified in according to determined illumination and contrast compensation parameters (unit 205). After that a residual block is created by unit 201. Then, the residual block is transformed by Discrete Cosine Transform (DCT), quantized (unit 202) and encoded by entropy encoder (unit 203). Side information (SI) required for decoding is also encoded by entropy encoder (unit 203).

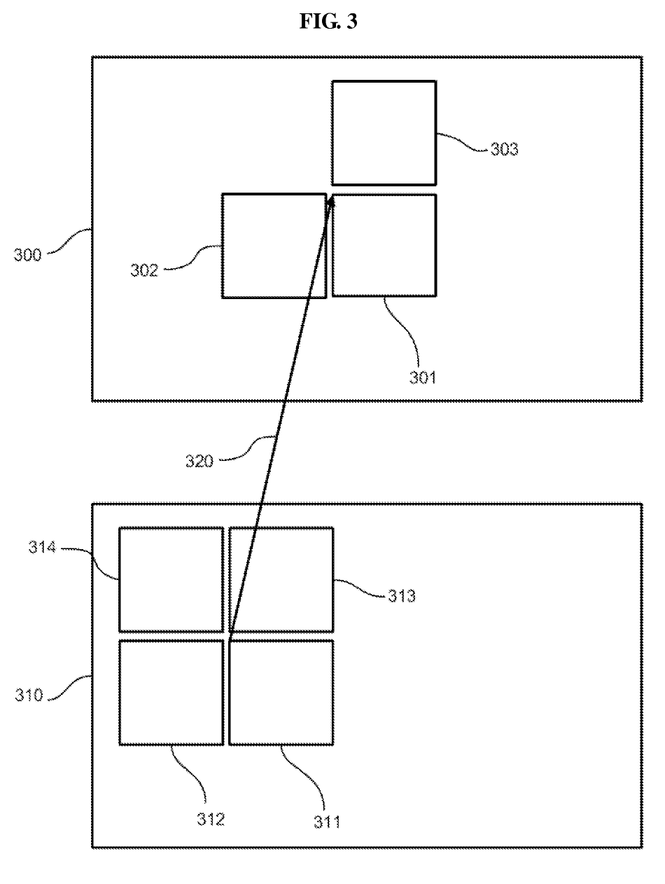

FIG. 3 contains a diagram for explaining the method of illumination and contrast compensation of a reference block in accordance with one of the embodiments. In accordance with FIG. 3, while the search for a reference block is in progress, the displacement vector (DV) 320 is assigned to the current block 311 of the currently encoded frame 310 iteratively. The DV points to the reference block 301 of the reference frame 300. The claimed method defines the illumination and contrast compensation function Ψ(x) as follows:

Ψ(x)−u·x,

The illumination and contrast compensation parameter α is described by following equation:

$$α = \frac{estMX}{ref MX} , \\ ref MX = \frac{1}{N \cdot M} \cdot {\sum }_{m = 1}^{M} {\sum }_{n = 1}^{N} S ( m + i , n + j ) .$$

refMX is a mean value of a reference block 301 with coordinates of left-top corner (i,j). S means reference frame 300. Value denoted as estMX is an estimation (approximation) of mean value for the current block 311.

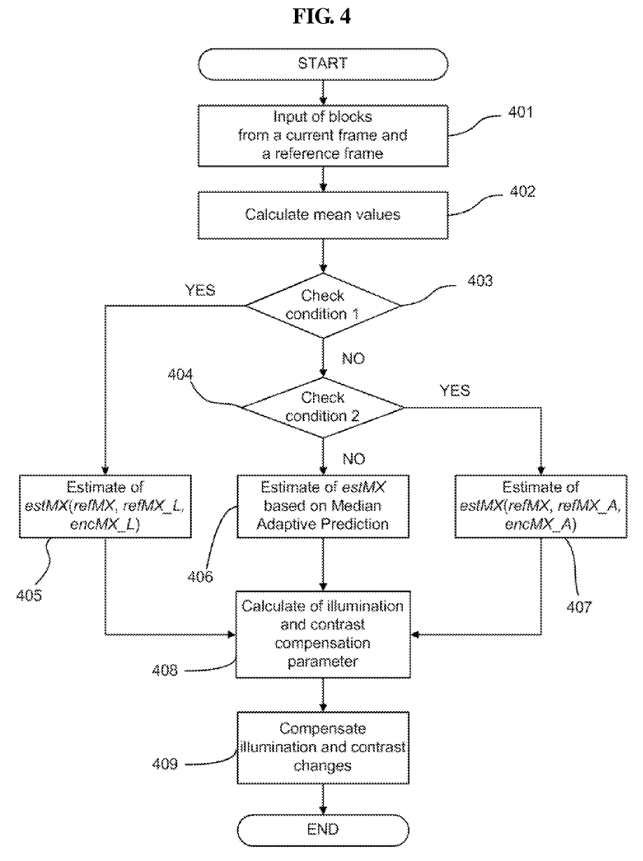

FIG. 4 contains the flowchart illustrating the method of compensating for illumination and contrast of a reference block, according to an embodiment. The method comprising following steps:
1. Receiving inputs of values of pixels of blocks 301, 302, 303, 311, 312, 313 and 314 (FIG. 4, 401).
2. Calculating the following mean values (FIG. 4, 402):
   calculating mean value encMX_L of the block 312

$$enc MX\_L = \frac{1}{P \cdot Q} \cdot {\sum }_{p = 1}^{P} {\sum }_{q = 1}^{Q} DI ( p , q ) ,$$

where DI(p,q) represents restored (already decoded) luminance value of pixel at position (p,q) of the block 312. Sizes of the block 312 are P×Q;
calculating the mean value encMX_A of the block 313

$$enc MX\_A = \frac{1}{U \cdot V} \cdot {\sum }_{u = 1}^{U} {\sum }_{v = 1}^{V} DI ( u , v ) ,$$

where DI(u,v) represents restored (encoded and then encoded) luminance value of pixel at position (u,v) of the block 313. Sizes of the block 313 are U×V;
calculating mean value refMX of a reference block 301;
calculating mean value refMX_L of the block 302:

$$ref MX\_L = \frac{1}{P \cdot Q} \cdot {\sum }_{p = 1}^{P} {\sum }_{q = 1}^{Q} S ( p + i , q + j - Q ) ; .$$

the sizes of the block 302 are equal to the sizes of the block 312;
calculating the mean value refMX_A of the block 303:

$$ref MX\_A = \frac{1}{U \cdot V} \cdot {\sum }_{u = 1}^{U} {\sum }_{v = 1}^{V} S ( u + i - U , v + j ) .$$

the sizes of the block 303 are equal to the sizes of the block 313,
3. Checking condition 1 (FIG. 4, 403): if the block 302 and the block 312 are available (i.e. blocks 302 and 312 are located inside the frame boundaries and if the reference frame is the synthesized frame, then all pixels belong to the block 302 are available (not occluded), when go to estimation of estMX value (FIG. 4, 405) in accordance to following expression:

$$est MX = \frac{refMX}{refMX\_L} \cdot encMX\_L .$$

Otherwise, go to checking condition 2 (FIG. 4, 404).
4. Checking condition 2 (FIG. 4, 404): if the block 303 and the block 313 are available (i.e. blocks 303 and 313 are located inside the frame boundaries and if the reference frame is the synthesized frame, then all pixels belong to the block 303 are available (not occluded), when go to estimation of estMX value (FIG. 4, 407) in accordance to following expression:

$$est MX = \frac{refMX}{refMX\_A} \cdot encMX\_A .$$

Otherwise, go to estimation of estMX value (FIG. 4, 406) in accordance to following expression:

estMX=MAP(encMX_{—}L,encMX_{—}A,encMX_{—}LA),

where MAP(x,y,z) is well-known Median Adaptive Predictor [Martucci S. A. <<Reversible compression of HDTV images using median adaptive prediction and arithmetic coding>>, in IEEE Int. Symp. on Circuits and Systems, 1990], encMX_LA is a mean value of the block 314:

$$enc MX\_LA = \frac{1}{U \cdot Q} \cdot {\sum }_{u = 1}^{U} {\sum }_{q = 1}^{V} DI ( u , q ) .$$

The sizes of the block 314 are U×Q and are equal to the corresponding sizes of the blocks 312 and 313.
5. Calculating the illumination and contrast compensation parameter α (FIG. 4, 408), by using the obtained values of estMX and refMX.
6. Performing illumination and contrast compensation (FIG. 4, 409) of the reference block 301, by using the calculated parameter α.

One should note that the reference frame 300 with blocks 301,302, 303 and restored (already coded/decoded) blocks 312, 313, 314 are available during encoding and decoding.

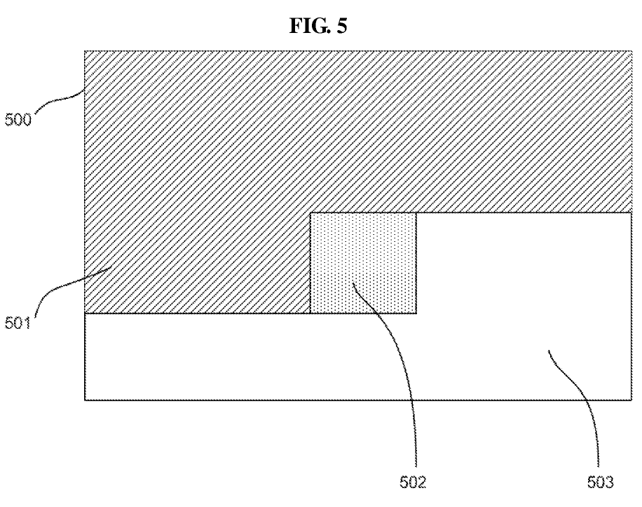

FIG. 5 illustrates geometric relationship between areas in the current frame 500. An area 501 of the current frame 500 is available during encoding and decoding of the currently coded block 502. The area 501 includes blocks 312, 313 and 314. The area 501 is called <<template area>>. An area 503 is not present during decoding of the current block 502 and should not contain blocks 312, 313 and 314. Therefore mentioned above method can be applied simultaneously both at encoder and decoder sides, and no additional information has to be placed into encoded bitstream.

Another embodiment comprises the pixel-wise illumination and contrast compensation of the reference block during predictive coding. The key idea is a pixel-wise estimation of the illumination and contrast parameter compensation based on the restored values of the pixels neighboring the current block, the values of the pixels of the reference frame and their similarity.

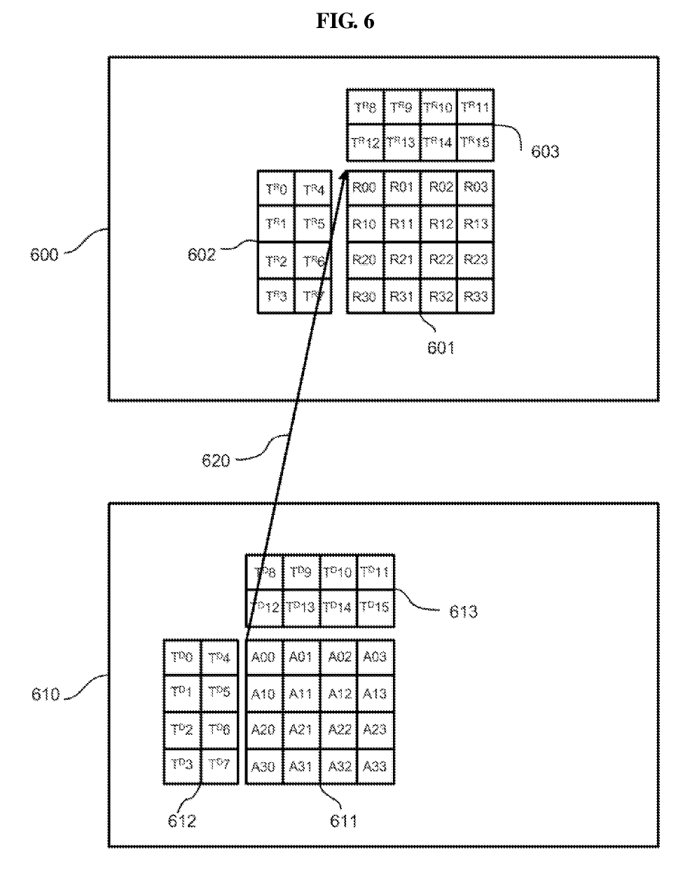

FIG. 6 illustrates particular implementation of this technique.

According to FIG. 6, while the search of a reference block is in progress, the displacement vector (DV) 620 is assigned for the current block 611 that belongs to the currently encoded frame 610. The DV points to the reference block 601 of the reference frame 600. The current block 611 contains values of pixels that are denoted as A00˜A33. The reference block 601 contains pixels that are denoted as R00˜R33. The restored values of the pixels (blocks 612 and 613) neighboring the current block are denoted by T₀^{D}˜T₁₅^{D}. The values of the pixels (blocks 602 and 603) neighboring the reference block which correspond to the restored pixels of the currently coded frame are denoted as T₀^{D}˜T₁₅^{D}. Note that total amount of the pixels in the block 612, 613 and 602, 603 are the same.

For each pixel position (i,j) in the reference block 601 the illumination and contrast compensation is performed in accordance with following equation:

Ψ(x_{i,j})=α_{i,j}·x_{i,j},

Here the illumination and contrast compensation pixel-wise parameter is described as:

$${α}_{i , j} = \frac{{estD}_{i , j}}{{estR}_{i , j}} ,$$

where estD_{i,j} is the first estimation value for the pixel position (i,j) in the reference block; estR_{i,j} is the second estimation value for the pixel position (i,j) in the reference block.

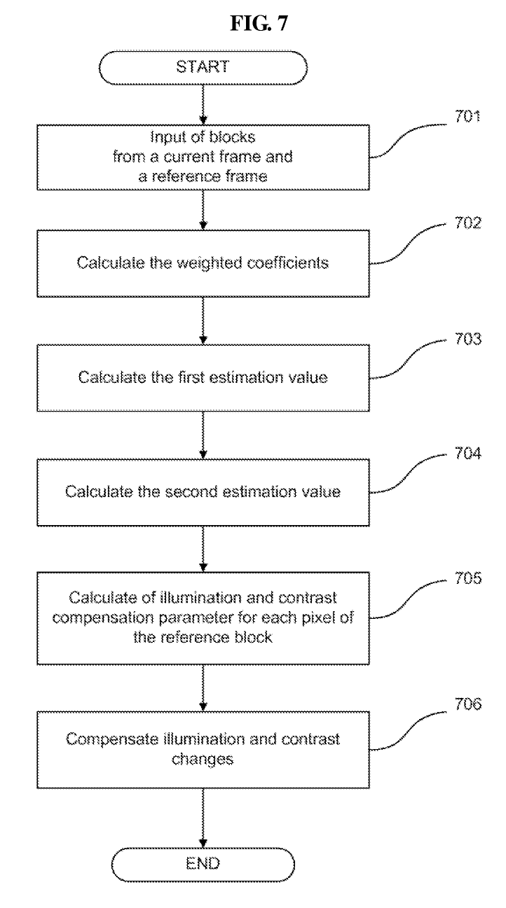

Flowchart of a method of pixel-wise illumination and contrast compensation of a reference block is shown in FIG. 7. The method comprises the following steps:
1. Receiving inputs of values of pixels of blocks 601, 602, 603 from the reference frame 600, block 611 and blocks 612, 613 from the template area of the currently coded frame 610 (operation 701).
2. Calculating weighted coefficients Wₖ(i,j), k=0, . . . , N for each pixel position (i,j) in the reference block 601 (operation 702). The weighted coefficients Wₖ(i,j) can be expressed by following equation:

$${W}_{k} ( i , j ) = exp ( - C \cdot {A}_{k} ( i , j ) ) , \\ C = \frac{σ}{2} , {A}_{k} ( i , j ) = \vert {R}_{i , j} - {T}_{k}^{R} \vert ,$$

where σ>0 defines smoothness degree and is determined experimentally. Here N is total amount of the pixels in blocks 612, 613 (or 602, 603). Basically, the weighted coefficients reflect the fact that the more value R_{i,j} is similar to Tₖ^{R}, the more contribution it gives to illumination and contrast parameter.
3. Calculating values of estD_{i,j} for each pixel position (i,j) in the reference block 601 (operation 703) in accordance with the following expression:

$$est {D}_{i , j} = {\sum }_{{k ∈ 0 … N - 1}_{k : \vert {T}_{k}^{R} - {T}_{k}^{D} \vert < Thr 1 and \vert {T}_{k}^{R} - {R}_{i , j} \vert < Thr 2}} {W}_{k} ( i , j ) \cdot {T}_{k}^{D} .$$

Thr1 and Thr2 are predetermined threshold values. The threshold values are used for excluding values of pixel neighboring the reference block which rather differ from the value R_{i,j} of the reference block and that rather differ from the values of the corresponding pixels neighboring the current block or the reference block.
4. Calculating values of estR_{i,j} for each pixel position (i,j) in the reference block 601 (operation 704) in accordance with the following expression:

$$est {R}_{i , j} = {\sum }_{{k ∈ 0 … N - 1}_{k : \vert {T}_{k}^{R} - {T}_{k}^{D} \vert \leq Thr 1 and \vert {T}_{k}^{R} - {R}_{i , j} \vert \leq Thr 2}} {W}_{k} ( i , j ) \cdot {T}_{k}^{R} .$$

The predetermined threshold values Thr1 and Thr2 are the same as in calculation of estD_{i,j}.
5. Calculating the illumination and contrast compensation parameter α_{i,j} (operation 705) for each pixel position (i,j) in the reference block 601, by using the obtained values of estD_{i,j} and estR_{i,j}.
6. Performing illumination and contrast compensation (operation 706) of the reference block 601, by using the calculated parameters α_{i,j}.

Still another embodiment is based on the following. Usually the values of the pixels neighboring the reference block are defined as a group of pixels that are immediately adjacent the reference block. In fact, displacement vector estimation procedure could select such motion/displacement vector that the values of the pixels neighboring the reference block are not similar to the restored values of the pixels neighboring the current block. One of examples is an area with quite uniform or periodic structure bordered by contrast areas. In this case the restored pixels neighboring the current block is located in the smooth area while the pixels neighboring the reference block will be appeared in the contrast area. More complex case is an area with large changes of intensity or sort of displacement of area in reference frame relative to corresponding area in encoded frame where are is defined as a group of pixels adjacent the reference of encoded block. In this case illumination and contrast compensation can operate incorrectly due-to the values of the corresponding pixels of the currently coded frame and the reference frame are differs strongly.

In order to sort out this problem, in an embodiment we propose usage of “float” (relative to the reference block) position of the mentioned group of the pixels neighboring the reference block.

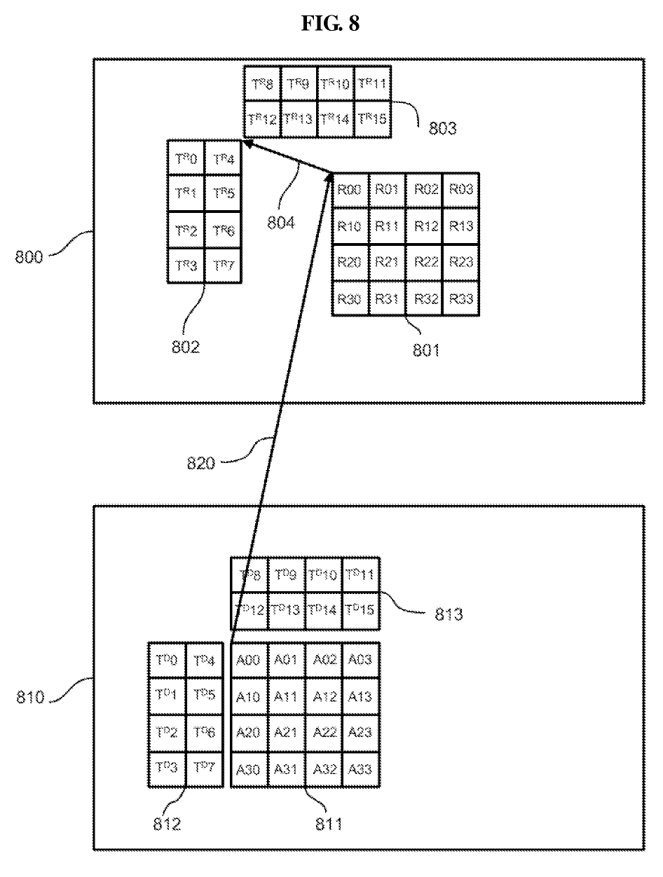

FIG. 8 explains claimed method in accordance with one of the embodiments. Referring FIG. 8, during the searching of a reference block, displacement vector (DV) 820 is assigned for the current block 811 of the currently coded frame 810. The DV points to the reference block 801 of the reference frame 800. Floating is determined by additional refinement displacement vector 804 which points to position of the pixels of the reference frame. The refinement displacement vector 804 is result of displacement estimation procedure. The estimation procedure is concluded in finding of DV 804 that defines minimum value of an error function that defines similarity degree of blocks 812, 813 and blocks 802, 803 correspondently. Persons, who are skilled in the art, could use any type of similarity functions, e.g.: Means Square Error, Sum of Absolute Differences, Mean Removed Sum of Absolute Differences etc. Vector 804 can be determined implicitly during encoding and decoding process without transmitting any additional information in the output bitstream.

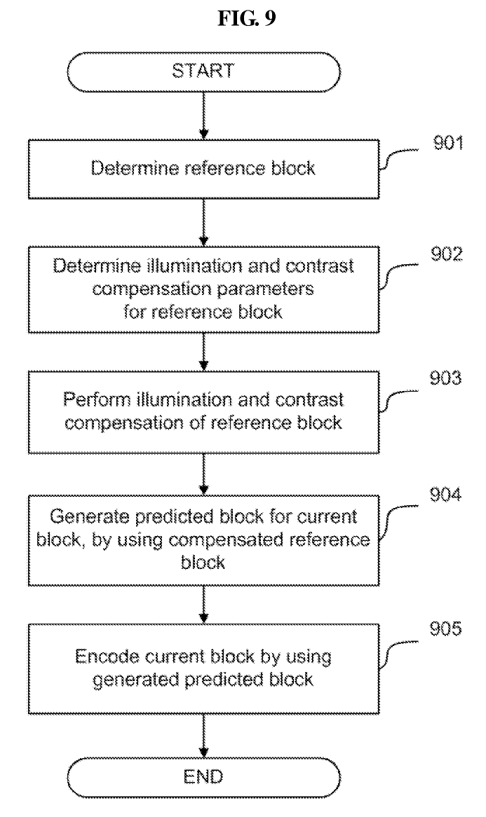

FIG. 9 is a flowchart which describes a method for multi-view video encoding based on the illumination and contrast compensation according to an embodiment. At the step 901, a reference block which is used for generation of a predicted block is determined. At the step 902, an illumination and contrast compensation parameters for illumination and contrast compensation of the determined reference block are determined. The determination of the illumination and contrast compensation parameters comprises:
receiving reconstructed (already decoded) values of the pixels neighboring the current block and values of the pixels neighboring the reference block;
determining relations between the values of the pixels of the reference block and the values of the pixels neighboring the reference block and relations between the restored values of the pixels neighboring the current block and the values of the pixels neighboring the reference block;
determining an illumination and contrast compensation parameter for illumination and contrast compensation of the reference block is based on the determined relations, values of the pixels of the reference block, restored values of the pixels neighboring the current block and values of the pixels neighboring the reference block.

At the step 903, by using the determined illumination and contrast compensation parameters, an illumination and contrast compensation of the reference block is performed. At the step 904, by using the illumination and contrast compensated reference block, a predicted block for the current block is generated. At the step 905, by using the generated predicted block, the current block is encoded. In particular, information about the reference block is encoded if it is needed for decoding. At the same time the determined illumination and contrast compensation parameters is not encoded.

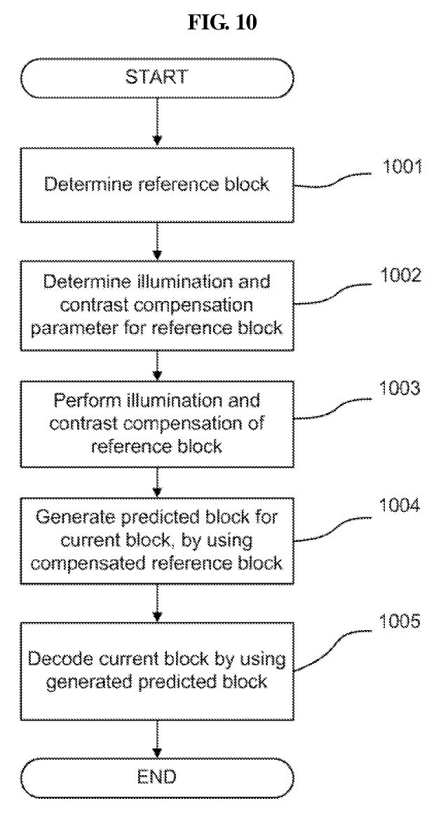

FIG. 10 describes the method for multi-view video decoding based on the illumination and contrast compensation according to an exemplary embodiment. In accordance with FIG. 10, information about the reference block is decoded in case of requirements of decoding. The decoded information can be used for determination of a reference block at the step 1001. At the step 1002, an illumination and contrast compensation parameters for illumination and contrast compensation of the reference block are determined. The determination of the illumination and contrast compensation parameters comprises:
receiving reconstructed (already decoded) values of the pixels neighboring the current block and values of the pixels neighboring the reference block;
determining relations between the values of the pixels of the reference block and the values of the pixels neighboring the reference block and relations between the restored values of the pixels neighboring the current block and the values of the pixels neighboring the reference block; and
determining the illumination and contrast compensation parameter for illumination and contrast compensation of the reference block is based on the determined relations, values of the pixels of the reference block, restored values of the pixels neighboring the current block and values of the pixels neighboring the reference block.

At the step 1003, by using the determined illumination and contrast compensation parameters, an illumination and contrast compensation of the reference block is performed. At the step 1004, by using the illumination and contrast compensated reference block, the predicted block for the current block is generated. At the step 1005, by using the generated predicted block, the current block is decoded.

The described disclosure may be implemented for encoding and decoding multi-view video sequences.

The variants of embodiments described above are presented as examples and are not restrictive. The scope of protection is determined by the enclosed claims.

The method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. A method for local compensating of illumination and contrast discrepancy between a reference block and an encoded block at the predicting stage of a multi-view coding process, the method comprising:
receiving values of pixels of a current block in a encoded frame and values of pixels of a reference block in a reference frame;
receiving already decoded and restored values of the pixels neighboring the current block of a currently coded frame and the values of the pixels neighboring the reference block of the reference frame;
determining relations between the values of the pixels of the reference block and the values of the pixels neighboring the reference block and relations between the restored values of the pixels neighboring the current block and the values of the pixels neighboring the reference block;
determining an illumination and contrast compensation parameters for illumination and contrast compensation of discrepancy (mismatch) compensation between reference and encoded blocks on the basis of the determined relations, values of the pixels of the reference block, restored values of the pixels neighboring the current block and values of the pixels neighboring the reference block; and
performing illumination and contrast compensation of the discrepancy (mismatch) between the reference block and the encoded block, by using the determined illumination and contrast compensation parameters.

2. The method as in claim 1, wherein the determining relations, and the determining an illumination and contrast compensation parameters comprises:
calculating statistical characteristics of the values of the restored pixels neighboring the current block, statistical characteristics of the values of the pixels of the reference block and statistical characteristics of the values of the pixels neighboring the reference block;
determining relations between the statistical characteristics of the values of the pixels of the reference block and the restored values of the pixels neighboring the reference block; and
calculating an illumination and contrast compensation parameter for illumination and contrast compensation of the reference block on the basis of the received statistical characteristics for the current block and the statistical characteristics of the reference block.

3. The method as in claim 1, wherein the determining relations, and the determining an illumination and contrast compensation parameters comprises:
calculating mean value for the restored pixels neighboring the current block and located to the left of the current block, mean value for the restored pixels neighboring the current block and located on the top of the current block, mean value for the pixels of the reference block, mean value of the pixels neighboring the reference block and located to the left of the reference block, and mean value of the pixels neighboring the reference block and located on the top of the reference block;
in case of presence of the restored pixels neighboring the current block and located to the left of the current block and presence of the pixels neighboring the reference block and located to the left of the reference block, calculating ratio value between the mean value of the pixels of the reference block and the mean value of the pixels neighboring the reference block and located to the left of the reference block; calculating product of the ratio value and the mean value of the restored pixels neighboring the current block and located to the left of the current block; determining an illumination and contrast compensation parameter as ratio between calculated product and mean value for the pixels of the reference block;
in case of presence of the restored pixels neighboring the current block and located over the current block and presence of the pixels neighboring the reference block and located over the reference block, calculating ratio value between the mean value of the pixels of the reference block and the mean value of the pixels neighboring the reference block and located over the reference block; calculating product of the ratio value and the mean value of the restored pixels neighboring the current block and located over the current block; determining an illumination and contrast compensation parameter as ratio between calculated product and mean value for the pixels of the reference block; and
otherwise, using Median Adaptive Prediction for calculation of estimation for mean value of the current block; determining an illumination and contrast compensation parameter as ratio between the estimated mean value of the pixels of the current block and the mean value for the pixels of the reference block.

4. The method as in claim 1, wherein the determining relations, and the determining an illumination and contrast compensation parameters comprises:
calculating a first estimation value estD_{i,j} for each pixel position (i,j) in the reference block, wherein the first estimation value estD_{i,j} is a function of a linear combination of the restored values Tₖ^{D} of the pixels neighboring the current block, k=0, . . . , N−1, N is amount of pixels neighboring the current block and the reference block;
calculating a second estimation value estR_{i,j} for each pixel position (i,j) in the reference block, where the second estimation value estR_{i,j} is a function of a linear combination of the values Tₖ^{R} of the pixels neighboring the reference block, k=0, . . . , N−1;
determining an illumination and contrast compensation parameter for illumination and contrast compensation for each pixel position in the reference block on the basis of the first estimation value estD_{i,j}, the second estimation value estR_{i,j}, the values R_{i,j} of pixels of the reference block, the restored values Tₖ^{D} of the pixels neighboring the current block and the values Tₖ^{R} of the pixels neighboring the reference block; and
performing illumination and contrast compensation for each pixel position in the reference block, by using the determined illumination compensation parameters.

5. The method as in claim 4, wherein the determining relations, and the determining an illumination and contrast compensation parameters comprises:
calculating the first estimation value estD_{i,j} as
estD_{i,j}=Σ_{k=0 . . . N-1}Wₖ(i,j)·Tₖ^{D},
where Wₖ(i,j), k=0, . . . , N−1 are a predetermined weighted coefficients, and Tₖ^{D}, k=0, . . . , N−1 is the restored values of the pixels neighboring the current block, N is amount of pixels neighboring the current block and the reference block;
calculating the second estimation value estR_{i,j} as
estR_{i,j}=Σ_{k=0 . . . N-1}Wₖ(i,j)·Tₖ^{R},
where Wₖ(i,j), k=0, . . . , N−1 are a predetermined weighted coefficients, and Tₖ^{R}, k=0, . . . , N−1 are the values of the pixels neighboring the reference block, N is amount of pixels neighboring the current block and the reference block;
determining, in case where the second estimation estR_{i,j} is not 0, an illumination and contrast compensation parameter for illumination and contrast compensation for each pixel position in the reference block, where the parameter is a ratio
$${α}_{i , j} = \frac{{estD}_{i , j}}{{estR}_{i , j}} ;$$
otherwise, the compensation parameter α_{i,j} is set as 1; and
performing compensation of illumination and contrast of the reference block by means of multiplying the value of each pixel of the reference block R_{i,j} to the corresponding compensation parameter α_{i,j}.

6. The method as in claim 5, wherein the calculating the first estimation value and the second estimation value for each position of the pixel in the reference block comprises:
calculating weighted coefficients Wₖ(i,j), k=0, . . . , N−1 for the first estimation value estD_{i,j} and the second estimation value estR_{i,j}, wherein for each pixel position (i,j) in the reference block the weighted coefficient Wₖ(i,j) is equal to the non-increasing function of the absolute difference:

|R_{i,j}−Tₖ^{R}|,
that provides inverse proportional increasing/decreasing of Wₖ(i,j) depending on decreasing/increasing the absolute difference correspondently, R_{i,j} is the value of the pixel of the reference block, Tₖ^{R} (k=0, . . . , N−1) is the value of the pixel neighboring the reference block, and N is amount of pixels neighboring the current block and the reference block.

7. The method of claim 5, wherein the calculating the first estimation value and the second estimation value for each pixel position in the reference block comprises:
calculating weighted coefficients Wₖ(i,j), k−0, . . . , N−1 for the first estimation value estD_{i,j} and the second estimation value estR_{i,j}, wherein for each pixel position (i,j) in the reference block the weighted coefficient Wₖ(i,j) is equal to the non-increasing function of an absolute difference:

|R_{i,j}−Tₖ^{R}|,
that provides inverse proportional increasing/decreasing of Wₖ(i,j) depending on decreasing/increasing the absolute difference correspondently; in case of

|Tₖ^{R}−R_{i,j}|≦Thr,
where Thr is predetermined threshold; otherwise Wₖ(i,j)=0, wherein R_{i,j} is the value of the pixel of the reference block, Tₖ^{R} (k=0, . . . N−1) is the value of the pixel neighboring the reference block.

8. The method of claim 5, wherein the calculating the first estimation value and the second estimation value for each pixel position in the reference block comprises:
calculating predetermined weighted coefficients Wₖ(i,j), k=0, . . . , N−1 for the first estimation value estD_{i,j} and the second estimation value estR_{i,j}, wherein for each pixel position (i,j) in the reference block the weighted coefficient Wₖ(i,j) is equal to the non-increasing function of an absolute difference:

|R_{i,j}−Tₖ^{R}|,
that provides inverse proportional increasing/decreasing of Wₖ(i,j) depending on decreasing/increasing the absolute difference correspondently; in case of

|Tₖ^{R}−Tₖ^{D}|≦Thr1,
where Tₖ^{D} (k=0, . . . , N−1) is the value of the pixel neighboring the current block, Thr1 is a first predetermined threshold; and

|Tₖ^{R}−R_{i,j}|≦Thr2,
where Thr2 is a second predetermined threshold; otherwise Wₖ(i,j)−0, wherein R_{i,j} is the value of the pixel of the reference block, Tₖ^{R} (k=0, . . . , N−1) is the value of the pixel neighboring the reference block.

9. The method of claim 5, wherein the calculating the first estimation value and the second estimation value for each pixel position in the reference block comprises:
calculating weighted coefficients Wₖ(i,j), k=0, . . . , N−1 for the first estimation value estD_{i,j} and the second estimation value estR_{i,j}, wherein for each pixel position (i,j) in the reference block the weighted coefficient Wₖ(i,j) is equal to
Wₖ(i,j)=exp(−C·Aₖ(i,j)),
where C is predetermined constant greater than 0 and Aₖ(i,j) is equal to
Aₖ(i,j)=|R_{i,j}−Tₖ^{R}|,
where R_{i,j} is the value of the pixel of the reference block, Tₖ^{R} (k=0, . . . , N−1) is the value of the pixel neighboring the reference block, in case of

|Tₖ^{R}−R_{i,j}|≦Thr,
where Thr is predetermined threshold; otherwise Wₖ(i,j)=0.

10. The method of claim 5, wherein the calculating the first estimation value and the second estimation value for each pixel position in the reference block comprises:
calculating weighted coefficients Wₖ(i,j), k=0, . . . , N−1 for the first estimation value estD_{i,j} and the second estimation value estR_{i,j}, wherein for each pixel position (i,j) in the reference block the weighted coefficient Wₖ(i,j) is equal to
Wₖ(i,j)=exp(−C·Aₖ(i,j)),
where C is predetermined constant greater than 0 and Aₖ(i,j) equals
Aₖ(i,j)=|R_{i,j}−Tₖ^{R}|,
where R_{i,j} is the value of the pixel of the reference block, Tₖ^{R} (k=0, . . . , N−1) is the value of the pixel neighboring the reference block, in case of

|Tₖ^{R}−Tₖ^{D}|≦Thr1,
where Tₖ^{D} (k=0, . . . , N) is the value of the pixel neighboring the current block, Thr1 is a first predetermined threshold; and

|Tₖ^{R}−R_{i,j}|≦Thr2,
where Thr2 is a second predetermined threshold; otherwise Wₖ(i,j)=0.

11. The method of claim 1, wherein the positions of the restored values of the pixels neighboring the currently encoded block and the values of the pixels neighboring the reference block are adaptively determined instead of the corresponding pixels occupying the predetermined positions.

12. A method for multi-view video encoding based on the local illumination and contrast compensation of a reference block, the method comprising:
determining the reference block that is used for generating a predicted block for the current block;
determining an illumination and contrast compensation parameters for illumination and contrast compensation of the reference block during or after determination of the reference block;
performing illumination and contrast compensation of the determined reference block using the determined illumination and contrast compensation parameters;
generating the predicted block for the current block using the illumination and contrast corrected reference block; and
encoding the current block using the generated predicted block without encoding of determined illumination and contrast compensation parameters; encoding of information about the position of the reference block if it is needed for decoding.

13. The method of claim 12, wherein the determining of the illumination and contrast compensation parameters comprises:
receiving reconstructed values of the pixels neighboring the current block and values of the pixels neighboring the reference block;
determining numerical ratios between the values of the pixels of the reference block and the values of the pixels neighboring the reference block and numerical relations between the restored values of the pixels neighboring the current block and the values of the pixels neighboring the reference block; and
determining an illumination and contrast compensation parameter for illumination and contrast compensation of the reference block is based on the determined numerical relations, values of the pixels of the reference block, restored values of the pixels neighboring the current block and values of the pixels neighboring the reference block.

14. A method for multi-view video decoding based on the illumination and contrast compensation, the method comprising:
decoding information about a reference block if it is necessary for determining the reference block of the current block and determining the reference block;
determining an illumination and contrast compensation parameters for illumination and contrast compensation of the determined reference block;
performing illumination and contrast compensation of the determined reference block using the determined illumination and contrast compensation parameters;
generating the predicted block for the current block, using the illumination and contrast corrected reference block; and
decoding the current block using the generated predicted block and the determined illumination and contrast compensation parameters.

15. The method of claim 14, wherein the determining of the illumination and contrast compensation parameters comprises:
receiving reconstructed values of the pixels neighboring the current block and values of the pixels neighboring the reference block;
determining numerical ratios between the values of the pixels of the reference block and the values of the pixels neighboring the reference block and relations between the restored values of the pixels neighboring the current block and the values of the pixels neighboring the reference block; and
determining an illumination and contrast compensation parameter for illumination and contrast compensation of the reference block is based on the determined relations, values of the pixels of the reference block, restored values of the pixels neighboring the current block and values of the pixels neighboring the reference block.
